(19) United States
(12) Patent Application Publication
(10) Pub. No.: US 2016/0355090 A1
(43) Pub. Date: Dec. 8, 2016

(54) INFORMATION NOTIFICATION DEVICE

(71) Applicant: TOYOTA JIDOSHA KABUSHIKI KAISHA, Toyota-shi (JP)

(72) Inventors: Toshio MURATA, Toyota-shi (JP); Masakazu SHINKAI, Toyota-shi (JP); Tadashi NAKAGAWA, Miyoshi-shi (JP)

(73) Assignee: TOYOTA JIDOSHA KABUSHIKI KAISHA, Toyota-shi (JP)

(21) Appl. No.: 15/154,042

(22) Filed: May 13, 2016

(30) Foreign Application Priority Data
Jun. 2, 2015 (JP) 2015-112360

(51) Int. Cl. B60K 35/00; F01N 5/02; F02D 41/02

(52) U.S. Cl. CPC B60K 35/00; F02D 41/0235; F01N 5/02

(57) ABSTRACT

There is provided an information notification device that is able to encourage a driver to drive in such a way that water condensate inside an exhaust pipe is discharged. The information notification device includes a notification unit that notifies a driver about a blockage in an exhaust pipe or about a possibility of a blockage occurring in an exhaust pipe, and a control unit that, based on output results from various sensors, predicts a blockage caused by water condensate freezing inside the exhaust pipe, and when it has predicted such a blockage, controls the notification unit such that the driver is notified.

### CROSS-REFERENCE TO RELATED APPLICATION

This application is based on and claims priority under 35 USC 119 from Japanese Patent Application No. 2015-112360 filed on Jun. 2, 2015, which is incorporated by reference herein.

### BACKGROUND

Technical Field

The present invention relates to an information notification device that is installed in a vehicle, and notifies a driver about information such as warnings and the like.

Related Art

In the exhaust pipe of a vehicle, water condensation may occur, causing the exhaust pipe to rust. In particular, when an exhaust heat recovery device that recovers exhaust heat from the exhaust pipe and the like is installed, water condensation may easily occur by the cooling of the exhaust gas as the exhaust heat is recovered. The water condensate sometimes causes damage to a switching valve or the like that switches the flow path of the exhaust gas between a catalytic converter that cleans the exhaust gas, and the exhaust heat recovery device.

For this reason, an exhaust heat recovery system that prevents water condensate from coming into contact with the catalytic converter and the switching valve and the like has been proposed in Patent document 1 (Japanese Patent Application Laid-Open (JP-A) No. 2006-161593).

Specifically, in the exhaust heat recovery system described in Patent document 1, a heat exchanger for recovering exhaust heat is provided in parallel with the exhaust pipe between a branch pipe that branches off from the exhaust pipe, and a junction pipe that joins the exhaust pipe on the downstream side of the branch portion of the exhaust pipe. Between the branch portion and the junction portion of the exhaust pipe there is provided a flow path switching valve that switches the flow path of the exhaust gas to either the exhaust pipe or to the exhaust heat recovery heat exchanger. Moreover, a liquid holding portion that is capable of holding a liquid is provided in a portion that includes the area between the flow path switching valve and the junction portion on the exhaust pipe.

In Patent document 1, by holding water condensate in the holding portion, the water condensate is prevented from flowing back towards the upstream side and thereby damaging the switching valve and the like. However, in this configuration, the water condensate accumulates in the vicinity of the holding portion. Because of this, in a subzero environment, the water condensate may freeze inside the exhaust pipe. Depending on the conditions in which the vehicle is traveling, the frozen water inside the exhaust pipe may not necessarily evaporate, but may in fact remain, so that if more water condensate is generated and freezes as well, a decrease in the engine output and a worsening of the exhaust noise inside the vehicle may result (also known as a decrease in the NV performance). Therefore, there is considerable scope for improvement.

### SUMMARY

The present invention was conceived in view of the above-described circumstances, and it is an object thereof to provide an information notification device that is able to encourage a driver to drive in such a way that water condensate inside the exhaust pipe is discharged.

An information notification device according to a first aspect of the present invention includes: a notification unit that notifies a driver about a blockage in an exhaust pipe or about a possibility of a blockage occurring in an exhaust pipe; and a control unit that predicts a blockage caused by water condensate freezing inside the exhaust pipe, and when a blockage is predicted, controls the notification unit such that the driver is notified.

According to the first aspect of the present invention, the notification unit notifies the driver that a blockage has been generated, or that there is a possibility of a blockage being generated by freezing in the exhaust pipe. The driver is notified by means, for example, of a display, a lamp, a warning sound, a voice, or the like.

When a blockage caused by the freezing of water condensate in the exhaust pipe has been predicted, the control unit controls the notification unit such that the driver is notified. As a result, by notifying the driver that either a blockage has occurred because of freezing in the exhaust pipe, or that there is a possibility of a blockage occurring, the driver can be encouraged to drive in such a way that the water condensate inside the exhaust pipe is discharged. For example, if the driver confirms that a warning or the like has been issued and drives with an increased engine revolution speed or the like so as to discharge the water condensate, then any blockage of the exhaust pipe 58 that is caused by freezing can be prevented.

In the information notification device according to a second aspect of the present invention, the control unit additionally performs predetermined water condensate discharge driving control to discharge water condensate from inside the exhaust pipe after having notified the driver about the blockage. By doing this, blockages in the exhaust pipe may be prevented. Moreover, because the water condensate discharge driving control is performed after the notification has been given, any feelings of apprehension by the driver caused by the noise generated by the water condensate discharge driving control are appeased.

In the information notification device according to a third aspect of the present invention, the water condensate discharge driving control may be in the form of motoring in which a throttle valve is opened up, and cranking is performed without the engine being started up, or may be engine control in which the flow rate per unit time of exhaust gas discharged from the engine is raised above a predetermined normal state.

The information notification device according to a fourth aspect of the present invention further includes: an exhaust heat recovery device that is provided on a downstream side of a catalyst that cleans the exhaust gas, and recovers heat from the exhaust gas; and a recovery quantity adjustment unit that adjusts the quantity of heat recovered from the exhaust gas by the exhaust heat recovery device, and, wherein, in the water condensate discharge driving control, the control unit further controls the recovery quantity adjustment unit such that either heat recovery is prohibited or the heat recovery quantity is decreased.

In the information notification device according to a fifth aspect of the present invention, the control unit to controls the notification unit such that the driver continues to be notified until the possibility of a blockage occurring has ended.

In the information notification device according to a sixth aspect of the present invention further includes: a detection unit that detects at least one of physical quantities relating to the exhaust gas, physical quantities relating to the exhaust pipe, physical quantities relating to the environment, physical quantities relating to the engine, or the travel history, and wherein the control unit predicts the blockages based on detection results from the detection unit.

As is described above, according to the present invention, the effect is achieved that it is possible to provide an information notification device that is able to encourage a driver to drive in such a way that water condensate inside the exhaust pipe is discharged.

### BRIEF DESCRIPTION OF DRAWINGS

FIG. 1 is a view showing an example of the power configuration of a vehicle in which an information notification device according to embodiments of the present invention is installed.

FIG. 2 is a table showing an example of items to be detected in an exhaust pipe blockage prediction.

FIG. 3 is a block diagram showing the schematic configuration of an information notification device according to a first embodiment.

FIG. 4 is a flowchart showing an example of the flow of processing performed by a control unit of the information notification device according to the first embodiment.

FIG. 5 is a flowchart showing a variant example of the flow of processing performed by the control unit of the information notification device according to the first embodiment.

FIG. 6 is a block diagram showing the schematic configuration of an information notification device according to a second embodiment.

FIG. 7 is a flowchart showing an example of the flow of processing performed by a control unit of the information notification device according to the second embodiment.

FIG. 8 is a flowchart showing a variant example of the flow of processing performed by the control unit of the information notification device according to the second embodiment.

### DETAILED DESCRIPTION

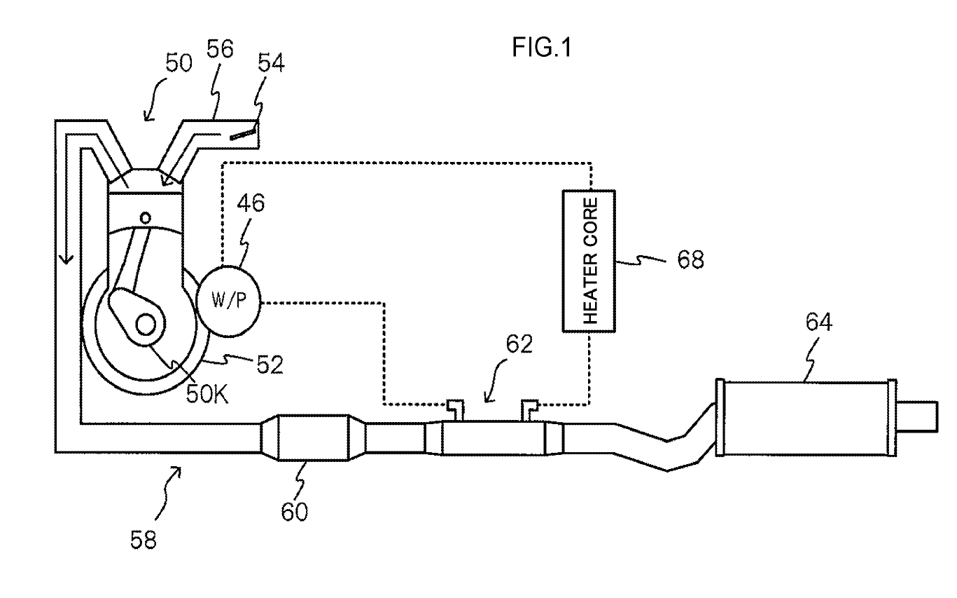

Hereinafter, an example of the embodiments of the present invention will be described in detail with reference to the drawings. FIG. 1 is a view showing an example of the power configuration of a vehicle in which an information notification device according to an embodiment of the present invention is installed. Note that in the present embodiment, a case in which a hybrid vehicle is used as an example is described.

As is shown in FIG. 1, the vehicle in which the information notification device according to the present embodiment is installed is provided with an engine 50 and a motor 52.

In the engine 50, as a result of a throttle valve 54 that is provided in an air intake pipe 56 being opened up, outside air is made to flow into the air intake pipe 56 by the negative pressure of the engine 50, and is then suctioned into the combustion chamber of the engine 50. Exhaust gas that is generated by the combustion action of the engine 50 is discharged via an exhaust pipe 58 from an exhaust port of the engine 50.

In the present embodiment, the motor 52 is provided and the vehicle is able to travel by means of the motor 52. For example, the motor 52 is connected to a rotation shaft that is connected to a crankshaft 50K via a clutch mechanism and the like, and the driving of the motor 52 is transmitted to the rotation shaft by means of this connection to the clutch mechanism and the like. Namely, by controlling an HV (Hybrid Vehicle) drive distribution system that includes a clutch mechanism and the like, control can be performed to switch the vehicle between traveling by means of the engine 50 and traveling by means of the motor 52.

A catalytic converter 60, an exhaust heat recovery device 62, and a muffler 64 are provided in that sequence on the path along which the exhaust gas is discharged in the exhaust pipe 58.

The catalytic converter 60 purifies noxious constituents contained in the exhaust gas discharged by the engine 50 by reducing and oxidizing them.

The exhaust heat recovery device 62 recovers heat contained in the exhaust gas from the engine 50 of the vehicle, and utilizes it for internal heating and for hastening the warming up of the engine 50 and the like. Specifically, cooling water that is used to cool the engine 50 is circulated by a water pump (W/P) 46 in the exhaust heat recovery device 62. The cooling water circulated to the exhaust heat recovery device 62 flows into a heater core 68, and is then returned to the engine 50. Namely, the exhaust heat recovery device 62 is provided above the flow path of the cooling water, so that the heat from the exhaust gas is recovered by the exhaust heat recovery device 62 and heats up the cooling water, and can be used as a heat source for the vehicle heater and to promote the warming of the engine and the like.

The muffler 64 reduces the noise that is generated when the exhaust gas discharged from the engine 50 is expelled to the outside (i.e., exhaust noise), and the noise that is generated when air is suctioned into the air intake pipe (i.e., air intake noise).

When the outside air temperature is sufficiently cold, the exhaust pipe 58 becomes saturated with water vapor from the air, and condensate forms on the exhaust pipe 58. The water condensate thereby generated causes the exhaust pipe 58 to rust. In particular, when the exhaust heat recovery device 42 is provided, as it is in a vehicle in which the information notification device according to the present embodiment is installed, it is easy for water condensate to be generated.

When water condensate has been generated and has remained in the exhaust pipe 58 without being discharged, if the engine 50 is turned off and the vehicle is left in a subzero environment, the water condensate may freeze inside the exhaust pipe 58. Furthermore, if the vehicle is a hybrid vehicle, as is the case in the present embodiment, because the vehicle is able to travel by means of the motor 52, travelling by this means in a subzero environment may cause the water condensate to freeze inside the exhaust pipe 58. Here, one of the factors causing water condensate to remain is the fact that because the exhaust pipe 58 is often formed having height differences in order for it to avoid other components, if the gas does not have sufficient flow velocity (i.e., sufficient engine revolution speed), then the water condensate might not be discharged towards the rear of the vehicle. If water condensate freeze in the exhaust pipe 58, depending on the circumstances in which the vehicle is traveling, the frozen water may not melt, but may instead remain in the exhaust pipe 58. If the water condensate remains in a frozen state, and yet more water condensate is generated and freezes, the exhaust pipe 58 may become blocked, and the resulting reduction in the exhaust performance may lead to a reduction in engine output, and that the exhaust noise inside the vehicle may also worsen.

Therefore, in the present embodiment, by predicting any blockage in the exhaust pipe 48 that is due to freezing and notifying the driver of this possibility, the driver is encouraged to drive in such a way that the discharge of water condensate from inside the exhaust pipe 58 is accelerated.

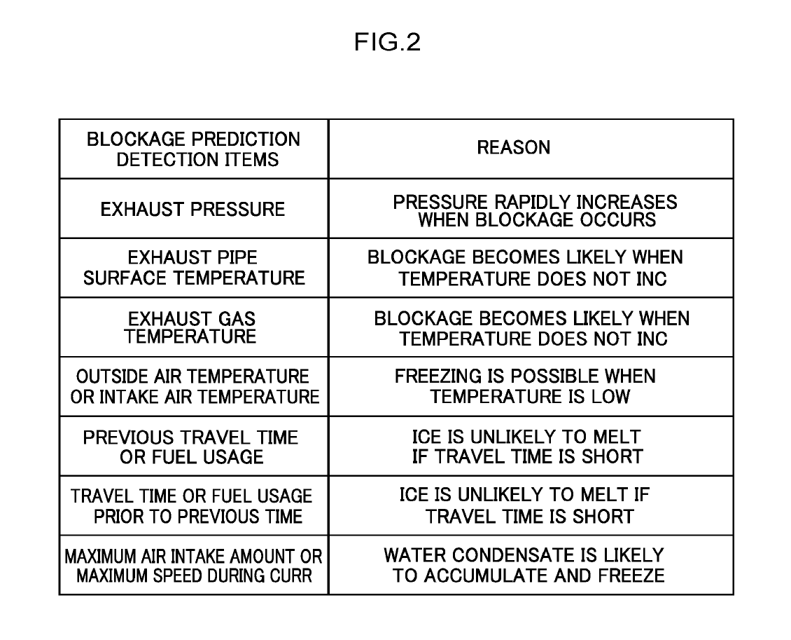

A blockage in the exhaust pipe 58 can be predicted by detecting at least one of physical quantities relating to the exhaust gas, physical quantities relating to the exhaust pipe 58, physical quantities relating to the environment, physical quantities relating to the engine 50, or the travel history. For example, by detecting blockage prediction items such as those shown in FIG. 2, a blockage can be predicted in the exhaust pipe 58.

Namely, because the exhaust pressure rapidly rises if the exhaust pipe 58 becomes blocked, a blockage in the exhaust pipe 58 can be predicted by monitoring the exhaust pressure. Moreover, if there is no rise in the surface temperature of the exhaust pipe 58, then the water condensate may freeze and block the exhaust pipe 58. Because of this, blockages in the exhaust pipe 58 can also be predicted by monitoring the surface temperature of the exhaust pipe 58. Moreover, if there is no rise in the temperature of the exhaust gas, then the water condensate may freeze and block the exhaust pipe 58. Because of this, blockages in the exhaust pipe 58 can be predicted by monitoring the temperature of the exhaust gas. Furthermore, if the outside air temperature and intake air temperature are sufficiently low, then the water condensate may freeze and block the exhaust pipe 58. Because of this, blockages in the exhaust pipe 58 can be predicted by monitoring the outside air temperature or the intake air temperature. Moreover, if the previous traveling time and the previous fuel usage were sufficiently low, then frozen water may not have melted and the exhaust pipe 58 may thereby become blocked. Because of this, blockages in the exhaust pipe 58 can be predicted by monitoring the previous traveling time or the previous fuel usage. Additionally, if the traveling time prior to the previous traveling time and the fuel usage prior to the previous fuel usage were also sufficiently low, then frozen water may not have melted and the exhaust pipe 58 may thereby become blocked. Because of this, blockages in the exhaust pipe 58 can be predicted by monitoring the traveling time prior to the previous traveling time or the fuel usage prior to the previous fuel usage. Moreover, if the current maximum air intake quantity (Ga) and the maximum speed are sufficiently low, then water condensate may not be discharged and may thereby become frozen. Because of this, blockages in the exhaust pipe 58 can be predicted by monitoring the maximum air intake quantity or the maximum speed.

Note that in FIG. 2, the exhaust pressure and exhaust gas temperature correspond to physical quantities relating to the exhaust gas, the exhaust pipe surface temperature corresponds to a physical quantity relating to the exhaust pipe 58, and the external temperature and the air intake temperature correspond to physical quantities relating to the environment. Moreover, the air intake temperature, the fuel usage quantity, and the maximum air intake quantity correspond to physical quantities relating to the engine 50, and the previous traveling time (or fuel usage quantity) and the traveling time prior to the previous traveling time (or fuel usage quantity) correspond to the travel history.

Furthermore, it is not necessary for all of the detection items shown in FIG. 2 to be monitored, and a blockage in the exhaust pipe 58 can be detected by monitoring at least one or more of these detection items.

Next, an example of the configuration of an information notification device that predicts a blockage in the exhaust pipe 58 caused by freezing and provides notification of this to a driver will be described.

### First Embodiment

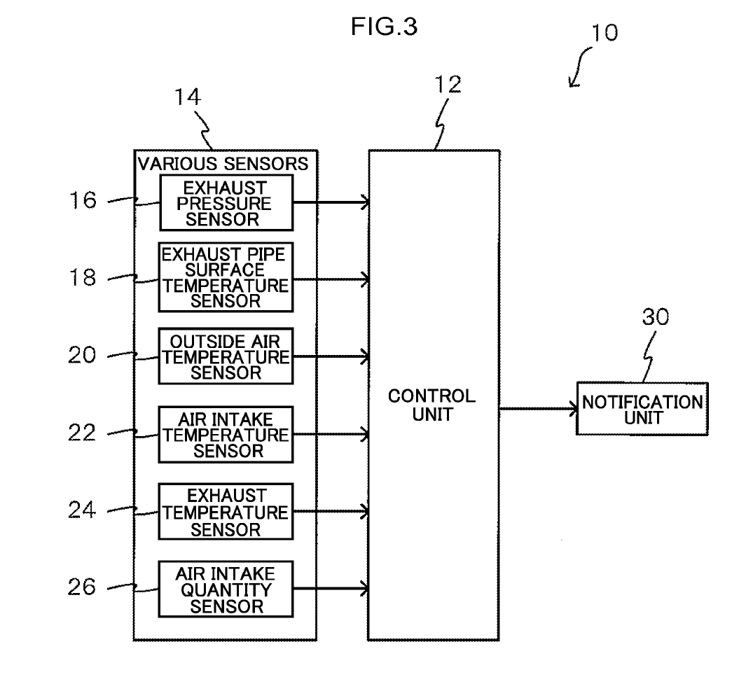

Firstly, an information notification device according to a first embodiment will be described. FIG. 3 is a block diagram showing the schematic configuration of an information notification device 10 according to the first embodiment.

The information notification device 10 according to the present embodiment is provided with a control unit 12 such as an ECU (Electronic Control Unit) that is used to predict blockages in the exhaust pipe 58 and notify a driver accordingly. The control unit 12 is formed by a microcomputer that includes a CPU (Central Processing Unit), ROM (Read Only Memory), and RAM (Random Access Memory).

Various sensors 14 that detect various types of information which is used to predict blockages in the exhaust pipe 58 are connected to the control unit 12.

In order to predict blockages in the exhaust pipe 58, the various sensors 14 detect at least one of physical quantities relating to the exhaust gas, physical quantities relating to the exhaust pipe, physical quantities relating to the environment, physical quantities relating to the engine 50, or the traveling history. In the present embodiment, the various sensors 14 include an exhaust pressure sensor 16, an exhaust pipe surface temperature sensor 18, an exhaust temperature sensor 24, an outside air temperature sensor 20, an air intake temperature sensor 22, and an air intake quantity sensor 26. These sensors are connected to the control unit 12. Note that these various sensors 14 are just some examples and are not limited to the sensors described above. Any of these sensors may be omitted, and other sensors may also be added thereto.

The exhaust pressure sensor 16 is provided inside the exhaust pipe 58, and detects the pressure of the exhaust gas by detecting the pressure inside the exhaust pipe 58. The exhaust pressure sensor 16 then outputs the detection results to the control unit 12.

The exhaust pipe surface temperature sensor 18 detects the surface temperature of the exhaust pipe 58 and outputs the detection results to the control unit 12.

The exhaust temperature sensor 24 detects the temperature of the exhaust gas flowing through the exhaust pipe 58, and outputs the detection results to the control unit 12.

The outside air temperature sensor 20 detects the outside air temperature and outputs the detection results to the control unit 12. The air intake temperature sensor 22 detects the air intake temperature in the engine 50, and outputs the detection results to the control unit 12. The air intake quantity sensor 26 detects the air intake quantity of the engine 50 and outputs the detection results to the control unit 12.

Based on the detection results from the various sensors 14, the control unit 12 predicts blockages in the exhaust pipe 58. Note that, it is possible to predict blockages in the exhaust pipe 58 by detecting the detection items for predicting a blockage given in FIG. 2 from the detection results from the various sensors 14. However, in the present embodiment, an example is described in which blockages in the exhaust pipe 58 are predicted by detecting the outside air temperature, the travel time, and the maximum air intake quantity out of these detection items.

Moreover, a notification unit 30 that, when a blockage in the exhaust pipe 58 has been predicted, is used to notify a driver about the blockage in the exhaust pipe 58, or about the possibility of a blockage in the exhaust pipe 58 is connected to the control unit 12. When a blockage has been predicted in the exhaust pipe 58, the control unit 12 controls the notification unit 30 such that the driver is notified about this blockage in the exhaust pipe 58 or about the possibility of a blockage occurring.

The method used by the notification unit 30 to notify the driver about a blockage in the exhaust pipe 58 may be one in which, for example, the notification is displayed on a multi information display, or is displayed on a navigation screen, or is given by the flashing of a warning lamp, or by the emitting of an audible warning alarm, or the emitting of a voice warning alarm.

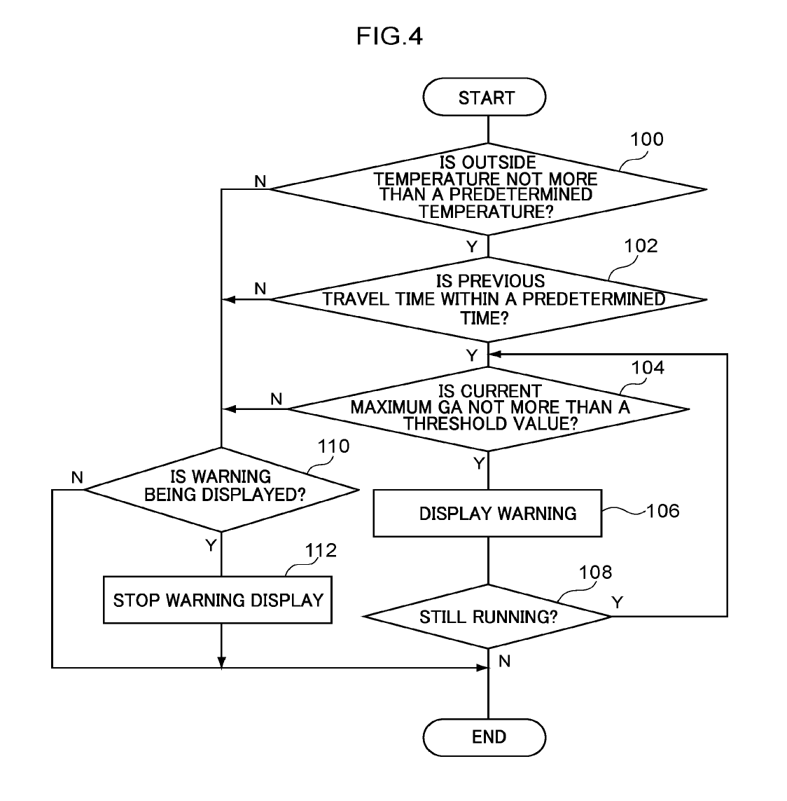

Next, an example of the specific processing performed by the control unit 12 of the information notification device 10 having the above-described configuration will be described. FIG. 4 is a flowchart showing an example of the flow of processing performed by the control unit 12 of the information notification device 10 according to the present embodiment. Note that the processing shown in FIG. 4 begins when an ignition switch (not shown) is turned on.

In step 100, based on the detection results from the outside air temperature sensor 20, the control unit 12 determines whether or not the outside air temperature is equal to or less than a predetermined temperature that has been set in advance. Namely, the control unit 12 determines whether or not the outside air temperature is equal to or less than a predetermined temperature at which there is a possibility that the exhaust pipe 58 will freeze and become blocked. If the result of this determination is YES, the routine moves to step 102, while if the result is NO, the routine moves to step 110.

In step 102, the control unit 12 determines whether or not the previous travel time was within a predetermined time. For example, the control unit 12 determines whether or not the previous travel time is within a predetermined time (for example, 10 minutes or the like) within which water condensate inside the exhaust pipe 58 will remain without getting discharged. If the result of this determination is YES, the routine moves to step 104, while if the result is NO, the routine moves to step 110.

In step 104, the control unit 12 determines whether or not the current maximum Ga (i.e., the air intake quantity) is equal to or less than a predetermined threshold value. In this determination, the control unit 12 determines whether or not the maximum air intake quantity is equal to or less than a predetermined threshold value at which water condensate will remain inside the exhaust pipe 58 without getting discharged. If the result of this determination is YES, the routine moves to step 106, while if the result is NO, the routine moves to step 110.

In step 106, the control unit 12 controls the notification unit 30 such that it displays a warning, and the routine moves to step 108. As a result of the driver being notified in this way about the possibility of a blockage being generated by freezing in the exhaust pipe 58, the driver can be encouraged to drive in such a manner so as to accelerate the discharge of water condensate inside the exhaust pipe 58, and so as to melt any ice therein. For example, if the driver confirms that a warning has been issued and drives with an increased engine revolution speed or the like so as to discharge the water condensate, then any blockage of the exhaust pipe 58 that is caused by freezing can be prevented.

In step 108, the control unit 12 determines whether or not the vehicle is still running. It makes this determination by determining whether or not the ignition switch (not shown) is still turned on. If the result of this determination is YES, the routine returns to step 104 and the above-described processing is repeated. If the result of this determination is NO, the processing routine is ended. Note that if the determination result in step 108 is YES, then it is also possible to return to step 105 instead of returning to step 104.

In step 110, the control unit 12 determines whether or not a warning is currently being displayed. Namely, the control unit 12 determines whether or not a warning is being displayed as a result of the above-described step 106. If the result of this determination is YES, the routine moves to step 112, while if the result of this determination is NO, the processing routine is ended.

In step 112, the control unit 12 controls the notification unit 30 such that no warning is displayed, and ends the processing routine.

In this way, in the present embodiment, because a blockage in the exhaust pipe 58 is predicted and the driver is notified of this, the driver can be encouraged to drive in such a way that the discharge of water condensate is accelerated.

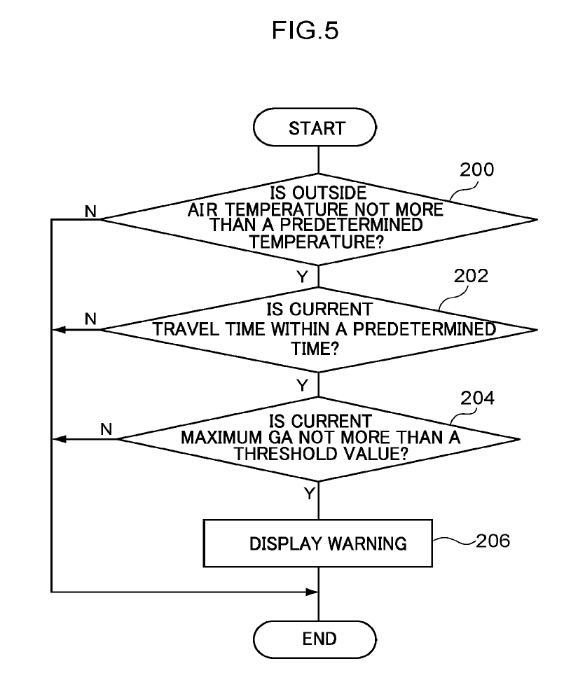

Note that, in FIG. 4, an example of a routine that starts when the ignition switch is turned on is described, however, it is also possible for the routine to start when the ignition switch is turned off. FIG. 5 is a flowchart showing a variant example of the flow of the processing performed by the control unit 12 of the information notification device 10 according to the present embodiment. The processing shown in FIG. 5 is started when the ignition switch (not shown) is turned off.

In step 200, the control unit 12 determines from the detection results from the outside air temperature sensor 20 whether or not the outside air temperature is equal to or less than a predetermined temperature that has been set in advance. Namely, the control unit 12 determines whether or not the outside air temperature is equal to or less than a predetermined temperature at which there is a possibility that the exhaust pipe 58 will freeze and become blocked. If the result of this determination is YES, the routine moves to step 202, while if the result is NO, the processing routine is ended.

In step 202, the control unit 12 determines whether or not the current travel time is within a predetermined time. For example, the control unit 12 determines whether or not the current travel time is within a predetermined time (for example, 10 minutes or the like) within which water condensate inside the exhaust pipe 58 does not get discharged but remains instead. If the result of this determination is YES, the routine moves to step 204, while if the result is NO, the processing routine is ended.

In step 204, the control unit 12 determines whether or not the current maximum Ga (i.e., the air intake quantity) is equal to or less than a predetermined threshold value. In this determination, the control unit 12 determines whether or not the maximum air intake quantity is equal to or less than a predetermined threshold value at which water condensate does not get discharged and remains inside the exhaust pipe 58. If the result of this determination is YES, the routine moves to step 206, while if the result is NO, the processing routine is ended.

In step 206, the control unit 12 controls the notification unit 30 such that it displays a warning, and then ends the processing routine. As a result of the driver being notified in this way about the possibility of a blockage being generated by freezing in the exhaust pipe 58 while the ignition switch is turned off, the driver can be encouraged to drive in such a manner so as to accelerate the discharge of water condensate inside the exhaust pipe 58, and so as to melt any ice therein.

### Second Embodiment

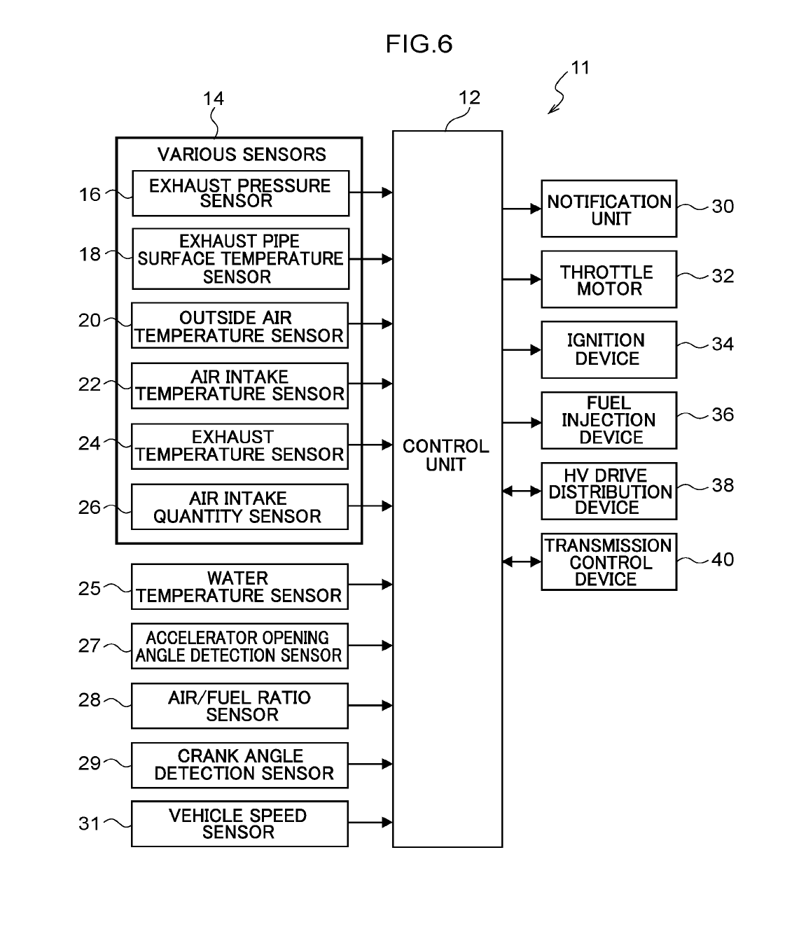

Next, an information notification device according to a second embodiment will be described. FIG. 6 is a block diagram showing the schematic configuration of an information notification device according to the second embodiment. Note that the same reference numeral is used to describe the configuration that is the same as in the first embodiment.

In the first embodiment, the driver was notified when a blockage was predicted in the exhaust pipe 58. However, in the second embodiment, not only is notification provided, but predetermined water condensate discharge driving control (described below in detail) is performed in order to discharge water condensate from the exhaust pipe 58.

An information notification device 11 according to the present embodiment is also provided with the control unit 12 such as an ECU or the like that is used to predict blockages in the exhaust pipe 58 and notify a driver about these.

Various sensors 14 that detect various types of information which is used to predict blockages in the exhaust pipe 58 are connected to the control unit 12.

In order to predict blockages in the exhaust pipe 58, the various sensors 14 detect at least one of physical quantities relating to the exhaust gas, physical quantities relating to the exhaust pipe, physical quantities relating to the environment, physical quantities relating to the engine 50, or the traveling history. In the same way as in the first embodiment, the various sensors 14 include an exhaust pressure sensor 16, an exhaust pipe surface temperature sensor 18, an exhaust temperature sensor 24, an outside air temperature sensor 20, an air intake temperature sensor 22, and an air intake quantity sensor 26, and these sensors are connected to the control unit 12. Note that these various sensors 14 are just some examples thereof and are not limited to the sensors described above. Any of these sensors may be omitted, and other sensors may also be added thereto.

Moreover, in the present embodiment, in addition to the above-described various sensors 14, a water temperature sensor 25, an accelerator opening angle detection sensor 27, an air/fuel ratio sensor 28, a crank angle detection sensor 29, and a vehicle speed sensor 31 and the like are also connected to the control unit 12.

The water temperature sensor 25 detects the temperature of the cooling water in the engine 50, the accelerator opening angle detection sensor 27 detects the accelerator opening angle, the air/fuel ratio sensor 28 detects the fuel/air ratio of the exhaust gas from the engine 50, the crank angle detection sensor 29 detects the crank angle, and the vehicle speed sensor 31 detects the vehicle speed. Detection results from each sensor are output to the control unit 12. The control unit 12 also controls the running of the engine 50 and the motor 52 using the detection results from these sensors.

Moreover, in the same way as in the above-described embodiment, a notification unit 30 that, when a blockage in the exhaust pipe 58 has been predicted, is used to notify a driver about the blockage is connected to the control unit 12. When a blockage in the exhaust pipe 58 has been predicted, the control unit 12 controls the notification unit 30 such that the driver is notified about this blockage in the exhaust pipe 58.

Furthermore, a throttle motor 32, an ignition device 34, a fuel injection device 36, an HV (Hybrid Vehicle) drive distribution device 38, and a transmission control device 40 are also connected to the control unit 12 in order to control operations of the engine 50. The throttle motor 32 adjusts the throttle opening angle by driving the throttle valve 54 that adjusts the air intake quantity of the engine 50. The ignition device 34 generates a spark that is needed to start combustion of the fuel-air mixture that has been compressed inside a cylinder of the engine 50. The fuel injection device 36 supplies a fuel-air mixture to the interior of the cylinders of the engine 50 by injecting fuel. The HV drive distribution device 38 controls the drive distribution of the engine 50 and the motor 52 that serve as the motive power sources that the vehicle uses to travel, and outputs an engine startup request to the control unit 12 when it is necessary for the engine 50 to be started up. The transmission control device 40 controls the gear ratios of a transmission whose gear ratios are capable of being altered (for example, a continuously variable transmission or the like).

The control unit 12 controls the operations of the engine 50 by controlling the throttle motor 32, the ignition device 34, and the fuel injection device 36 and the like based on the detection results from the various sensors 14. The control unit 12 also controls the drive distribution of the engine 50 and the motor 52 as well as the transmission in accordance with the situation.

Furthermore, the control unit 12 performs water condensate discharge driving control by controlling the engine 50 in order to discharge water condensate from the exhaust pipe 58.

In this water condensate discharge driving control, control to raise the engine revolution speed by motoring or racing or the like is performed so as to discharge the water condensate from inside the exhaust pipe 58.

Specifically, in motoring, the motor 52 is rotated without the engine 50 being started up so that the crankshaft 50K is turned over and air intake and air discharge are performed, and the crankshaft 50k is made to function as an air pump so that water condensate inside the exhaust pipe 58 is discharged from the exhaust pipe 58. At this time, during the motoring, the throttle valve 54 is opened up by driving the throttle motor 32 in order to perform the air intake.

In racing, in a load-free state (for example, while the vehicle is stopped, or while the power transmission to the wheels is interrupted) while the engine is running, the ignition device 34, the fuel injection deice 36, and the throttle motor 32 are controlled so as to increase the engine revolution speed, and thereby discharge water condensate from the exhaust pipe 58.

Another method of performing engine revolution speed increase control in addition to racing is to perform control to increase the engine revolution speed in a loaded state (for example, while the vehicle is traveling) while the engine is running, and to thereby increase the flow rate per unit time of exhaust gas that is expelled from the engine 50. Specifically, by controlling the ignition device 34, the fuel injection device 36, and the throttle motor 32, the engine revolution speed is increased, and at the same time, any unintended acceleration is prevented by controlling the HV drive distribution device 38 or the transmission control device 40 so as to cancel out the above-described increase in the engine revolution speed.

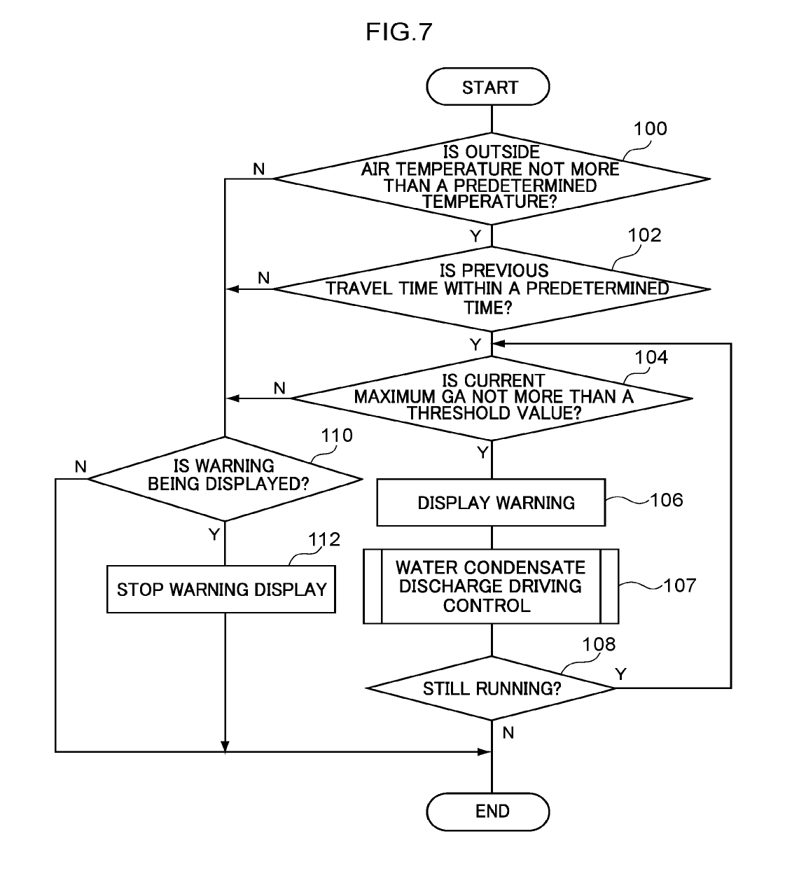

Next, an example of the specific processing performed by the control unit 12 of the information notification device 11 according to the present embodiment which has the above-described configuration will be described. FIG. 7 is a flowchart showing an example of the flow of processing performed by the control unit 12 of the information notification device 11 according to the present embodiment. Note that the processing shown in FIG. 7 begins when an ignition switch (not shown) is turned on. Furthermore, processing that is the same as in FIG. 3 of the first embodiment is described with the same reference numerals.

In step 100, the control unit 12 determines from the detection results from the outside air temperature sensor 20 whether or not the outside air temperature is equal to or less than a predetermined temperature that has been set in advance. Namely, the control unit 12 determines whether or not the outside air temperature is equal to or less than a predetermined temperature at which there is a possibility that the exhaust pipe 58 will freeze and become blocked. If the result of this determination is YES, the routine moves to step 102, while if the result is NO, the routine moves to step 110.

In step 102, the control unit 12 determines whether or not the previous travel time was within a predetermined time. For example, the control unit 12 determines whether or not the previous travel time is within a predetermined time (for example, 10 minutes or the like) within which water condensate inside the exhaust pipe 58 remains without getting discharged. If the result of this determination is YES, the routine moves to step 104, while if the result is NO, the routine moves to step 110.

In step 104, the control unit 12 determines whether or not the current maximum Ga (i.e., the air intake quantity) is equal to or less than a predetermined threshold value. In this determination, the control unit 12 determines whether or not the maximum air intake quantity is equal to or less than a predetermined threshold value at which water condensate remains inside the exhaust pipe 58 without getting discharged. If the result of this determination is YES, the routine moves to step 106, while if the result is NO, the routine moves to step 110.

In step 106, the control unit 12 controls the notification unit 30 such that it displays a warning, and the routine moves to step 107. By doing this, the driver can be notified of the possibility of a blockage being generated by freezing in the exhaust pipe 58.

In step 107, the control unit 12 performs water condensate discharge driving control and the routine then moves to step 108. In this water condensate discharge driving control, water condensate is discharged from inside the exhaust pipe 58 by performing engine revolution speed increase control including the above-described motoring or racing. As a result, it is possible to prevent any blockages inside the exhaust pipe 58 that are caused by frozen water condensate. Moreover, in the present embodiment, when a blockage in the exhaust pipe 58 has been predicted, because the water condensate discharge driving control is performed after the driver has been notified, the driver is forewarned that motor noise and engine noise and the like will increase due to the water condensate discharge driving control, so that any feelings of apprehension by the driver that are caused by the water condensate discharge driving control are appeased.

In step 108, the control unit 12 determines whether or not the vehicle is still running. It makes this determination by determining whether or not the ignition switch (not shown) is still turned on. If the result of this determination is YES, the routine returns to step 104 and the above-described processing is repeated. If the result of this determination is NO, the processing routine is ended. Note that if the determination result in step 108 is YES, then it is also possible to return to step 100 instead of returning to step 104.

In step 110, the control unit 12 determines whether or not a warning is currently being displayed. Namely, the control unit 12 determines whether or not a warning is being displayed as a result of the above-described step 106. If the result of this determination is

YES, the routine moves to step 112, while if the result of this determination is NO, the processing routine is ended.

In step 112, the control unit 12 controls the notification unit 30 such that no warning is displayed, and ends the processing routine.

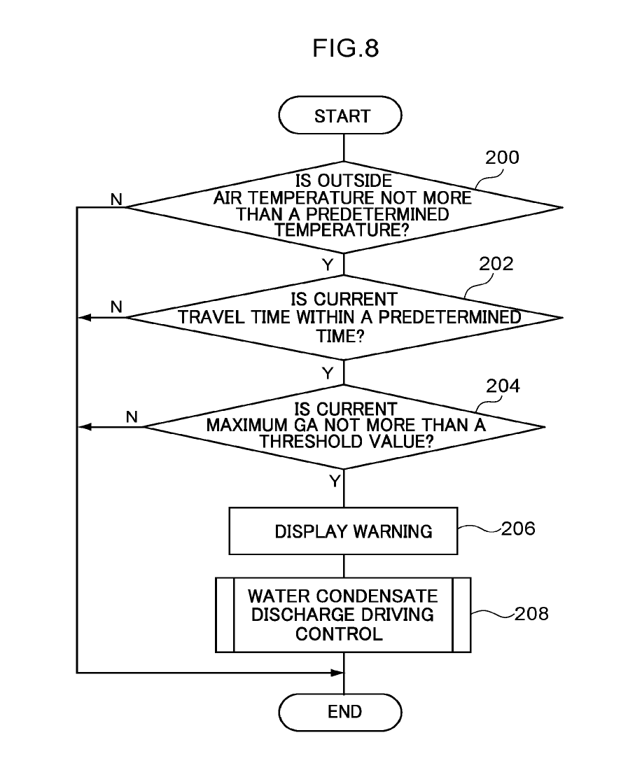

Note that, in FIG. 7, an example of a routine that starts when the ignition switch is turned on is described, however, it is also possible for the routine to start when the ignition switch is turned off. FIG. 8 is a flowchart showing a variant example of the flow of the processing performed by the control unit 12 of the information notification device 11 according to the present embodiment. The processing shown in FIG. 8 is started when the ignition switch (not shown) is turned off. Furthermore, processing that is the same as in FIG. 4 of the first embodiment is described with the same reference numerals.

In step 200, the control unit 12 determines from the detection results from the outside air temperature sensor 20 whether or not the outside air temperature is equal to or less than a predetermined temperature that has been set in advance. Namely, the control unit 12 determines whether or not the outside air temperature is equal to or less than a predetermined temperature at which there is a possibility that the exhaust pipe 58 will freeze and become blocked. If the result of this determination is YES, the routine moves to step 202, while if the result is NO, the processing routine is ended.

In step 202, the control unit 12 determines whether or not the current travel time is within a predetermined time. For example, the control unit 12 determines whether or not the current travel time is within a predetermined time (for example, 10 minutes or the like) within which water condensate inside the exhaust pipe 58 remains without getting discharged. If the result of this determination is YES, the routine moves to step 204, while if the result is NO, the processing routine is ended.

In step 204, the control unit 12 determines whether or not the current maximum Ga (i.e., the air intake quantity) is equal to or less than a predetermined threshold value. In this determination, the control unit 12 determines whether or not the maximum air intake quantity is equal to or less than a predetermined threshold value at which water condensate remains inside the exhaust pipe 58 without getting discharged. If the result of this determination is

YES, the routine moves to step 206, while if the result is NO, the processing routine is ended.

In step 206, the control unit 12 controls the notification unit 30 such that it displays a warning, and the routine moves to step 208. By doing this, the driver can be notified of the possibility of a blockage being generated by freezing in the exhaust pipe 58.

In step 208, the control unit 12 performs water condensate discharge driving control and then ends the processing routine. In this water condensate discharge driving control, water condensate is discharged from inside the exhaust pipe 58 by performing engine revolution speed increase control including the above-described motoring or racing. As a result, it is possible to prevent any blockages that are caused by frozen water condensate inside the exhaust pipe 58. Moreover, in the present embodiment, when a blockage in the exhaust pipe 58 has been predicted, because the water condensate discharge driving control is performed after the driver has been notified, the driver is forewarned that motor noise and engine noise and the like will increase due to the water condensate discharge driving control, so that any feelings of apprehension by the driver that are caused by the water condensate discharge driving control are appeased.

Note that in the second embodiment, engine revolution speed increase control including motoring and racing is described as an example of water condensate discharge driving, however, water condensate discharge driving is not limited to this. For example, it is also possible to employ control of the heat recovery quantity of the exhaust heat recovery device 62 as the water condensate discharge driving control. Namely, if the recovery of heat from the exhaust pipe 58 is restricted by prohibiting heat recovery by the exhaust heat recovery device 62, or by reducing the heat recovery quantity, the water condensate can be evaporated and thereby discharged. One method that may be used to control the heat recovery quantity in the exhaust heat recovery device 62 is, for example, to make the water pump 46 function as a recovery quantity adjustment unit, and to make the control unit 12 control the water pump 46 such that the flow rate of cooling water that is circulated to the exhaust heat recovery device 62 is either decreased or halted. Alternatively, it is also possible to employ a configuration in which a path that enables cooling water to be circulated to the exhaust heat recovery device 62, and a path that causes the cooling water to bypass the exhaust heat recovery device 62 are provided, and the circulation path is switched by means of a valve or the like, or else the control unit 12 controls a valve or the like so as to control the proportions flowing through the respective paths. Alternatively, it is also possible to employ a configuration in which an exhaust path that enables the exhaust gas discharged from the exhaust pipe 58 to pass through the exhaust heat recovery device 62, and an exhaust path that bypasses the exhaust heat recovery device 62 are provided, and the exhaust path is switched by means of a valve or the like, or else the control unit 12 controls a valve or the like so as to control the proportions flowing through the respective exhaust paths. Furthermore, when control of the heat recovery quantity of the exhaust heat recovery device 62 is used for the water condensate discharge driving control, then this method may also be used in conjunction with the engine revolution speed increase control which includes the above-described motoring and racing.

Moreover, the processing performed by the control unit 12 in the above-described embodiments may also be stored on a storage medium as a program and subsequently distributed.

Moreover, in each of the above-described embodiments, a case in which the information notification device is installed in a hybrid vehicle is described, however, the present invention is not limited to this, and it is also possible for the information notification device to be installed in a vehicle that only travels by means of the engine 50. In the case of a vehicle that only travels by means of the engine 50, the self-starter motor or the like can be used to replace the motor 52 in order to perform motoring.

The present invention is not limited to the above-described embodiments and it should be understood that various modifications and the like may also be made in addition to the above-described embodiments insofar as they do not depart from the spirit or scope of the present invention
10, 11 . . . Information notification device
12 . . . Control unit
14 . . . Various sensors (Detection units)
16 . . . Exhaust pressure sensor (Detection unit)
18 . . . Exhaust pipe surface temperature sensor (Detection unit)
20 . . . Outside air temperature sensor (Detection unit)
22 . . . Air intake temperature sensor (Detection unit)
24 . . . Exhaust temperature sensor (Detection unit)
26 . . . Air intake quantity sensor (Detection unit)
30 . . . Notification unit
46 . . . Water pump (Recovery quantity adjustment unit)
50 . . . Engine
52 . . . Motor
58 . . . Exhaust pipe
62 . . . Exhaust heat recovery device

What is claimed is:

1. An information notification device comprising:
a notification unit that notifies a driver about a blockage in an exhaust pipe or about a possibility of a blockage occurring in an exhaust pipe; and
a control unit that predicts a blockage caused by water condensate freezing inside the exhaust pipe, and when a blockage is predicted, controls the notification unit such that the driver is notified.

2. The information notification device according to claim 1, wherein, after notifying the driver about the blockage, the control unit additionally performs previously determined water condensate discharge driving control to discharge water condensate from inside the exhaust pipe.

3. The information notification device according to claim 2, wherein the water condensate discharge driving control is in the form of motoring in which a throttle valve is opened up, and cranking is performed without the engine being started up, or is engine control in which the flow rate per unit time of exhaust gas discharged from the engine is raised above a predetermined normal state.

4. The information notification device according to claim 2 further comprising:
an exhaust heat recovery device that is provided on a downstream side of a catalyst that cleans the exhaust gas, and recovers heat from the exhaust gas; and
a recovery quantity adjustment unit that adjusts the quantity of heat recovered from the exhaust gas by the exhaust heat recovery device, and wherein,
in the water condensate discharge driving control, the control unit further controls the recovery quantity adjustment unit such that either heat recovery is prohibited or the heat recovery quantity is decreased.

5. The information notification device according to claim 1, wherein the control unit controls the notification unit such that the driver continues to be notified until the possibility of a blockage occurring has ended.

6. The information notification device according to claim 1 further comprising:
a detection unit that detects at least one of physical quantities relating to the exhaust gas, physical quantities relating to the exhaust pipe, physical quantities relating to the environment, physical quantities relating to the engine, or the travel history, and wherein
the control unit predicts the blockages based on detection results from the detection unit.
